(19) United States
(12) Patent Application Publication
(10) Pub. No.: US 2008/0053344 A1
(43) Pub. Date: Mar. 6, 2008

(54) UTILITY TRAY FOR TRIPOD

(76) Inventor: William Chase Almond, Kennedale, TX (US)

Correspondence Address: LAW OFFICES OF JAMES E. WALTON, PLLC, 1169 N. BURLESON BLVD., SUITE 107-328, BURLESON, TX, 76028, US

(21) Appl. No.: 11/865,606

(22) Filed: Oct. 1, 2007

Related U.S. Application Data
(63) Continuation of application No. 29/265,417, filed on Aug. 31, 2006, now Pat. No. D552152.

(51) Int. Cl. A47B 5/02; F16M 11/04

(52) U.S. Cl. 108/152; 248/163.2

(57) ABSTRACT

A removable tray assembly is disclosed for use with a tripod or easel. The tray assembly includes a shelf having a back edge, a front edge, and two side edges. The tray assembly also includes a pair of support tabs spaced from the back edge of the shelf by respective slots. The removable tray is attached to two legs of the tripod, with one leg passing through each slot. The support tabs contact the side of the tripod legs opposite the shelf and thereby support the shelf in a cantilever fashion.

This application is a continuation of U.S. patent application Ser. No. 29/265,417, filed 2 Oct. 2007, titled “Utility Tray for Tripod.”

### BACKGROUND

1. Field of the Invention

This invention relates in general to removable shelves or trays for use with portable tripods and easels.

2. Description of Related Art

Tripods have been in widespread use for many years. They are commonly used as a support for a number of different applications. For example, tripods are often used for cameras, telescopes, and easels. Many such tripods are designed to be collapsible and easily portable. As a result, these tripods do not typically include any type of permanently-attached shelf or storage tray despite the usefulness that a shelf or tray would provide.

Because of this common shortcoming, various removable shelves have been introduced. For example, U.S. Pat. No. 6,240,857 to Elizer discloses a removable shelf assembly for use with a tripod or easel. However, the Elizer removable shelf requires support arms and clamps that add to the expense and complexity of the removable shelf. Thus, there remains a need in the art for a simple, inexpensive removable shelf that can be used with a tripod.

### DESCRIPTION OF THE DRAWINGS

The novel features believed characteristic of the invention are set forth in the appended claims. However, the invention itself, as well as a preferred mode of use, and further objectives and advantages thereof, will best be understood by reference to the following detailed description when read in conjunction with the accompanying drawings, wherein:

FIG. 1 shows a perspective view of a removable shelf according to the present disclosure;

FIG. 2 is a top view of the utility tray for tripod according to the present disclosure;

FIG. 3 shows a perspective view of a pair of removable shelves according to the present disclosure;

FIG. 4 shows a perspective view of an alternative removable shelf according to the present disclosure;

FIG. 5 shows a perspective view of another alternative removable shelf according to the present disclosure; and

FIG. 6 shows a perspective view of a photography system including a removable shelf according to the present disclosure.

### DETAILED DESCRIPTION OF THE PREFERRED EMBODIMENT

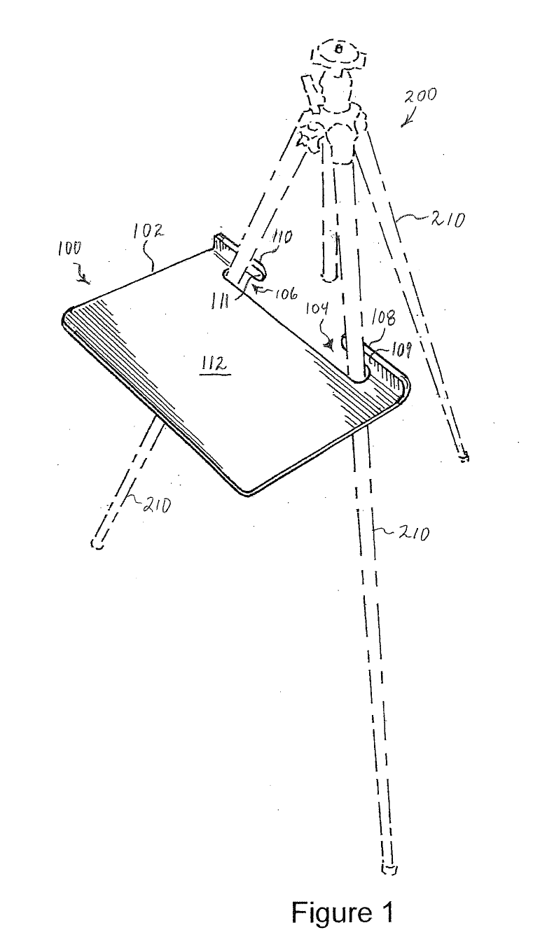

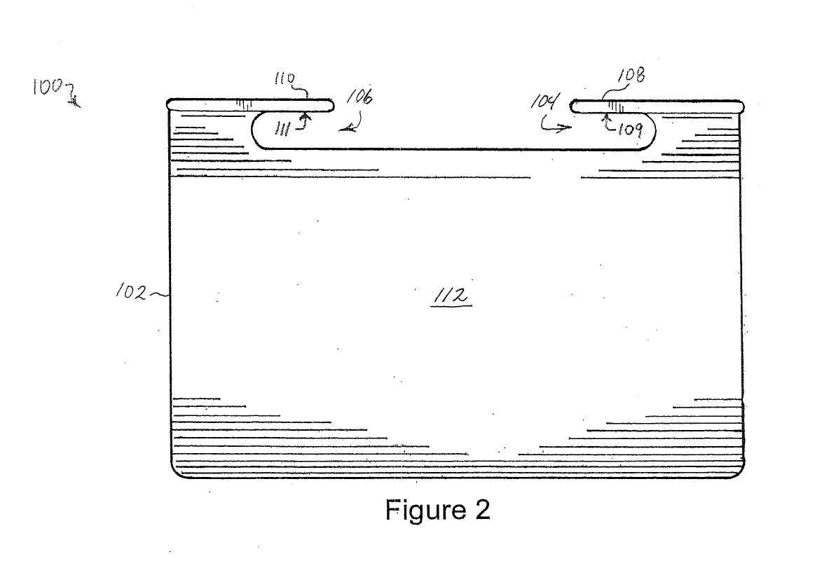

Referring first to FIGS. 1 and 2, FIG. 1 shows the tray assembly 100 mounted onto a tripod 200 (shown in phantom) and FIG. 2 shows a plan view of the tray assembly 100. The tray assembly 100 includes a shelf 102 that mounts onto two of the tripod legs 210 at slots 104, 106. The shelf 102 is supported in a cantilever fashion by a pair of support tabs 108, 110. The support tabs 108, 110 have respective contact surfaces 109, 111, and at least a portion of each of the contact surfaces 109, 111 is intended to contact a respective tripod leg 210 when the tray assembly 100 is installed. The shelf 102 hangs off the tripod 200 away from the tripod 200, thus providing a level, accessible work and storage surface 112 for an artist or other tripod user. A user can remove the tray assembly 100 from the tripod 200 by simply lifting the tray assembly 100 up and away from the tripod 200. Note that in a preferred embodiment, the entire contact surfaces 109, 111 extend substantially perpendicular to the surface 112. However, in alternative embodiments the angle between the surface 112 and the contact surfaces 109, 111 can be greater than 90 degrees so as to more closely match the angle of the tripod legs 210 relative to the surface 112.

The tray assembly 100 is formed of rigid material, such as plastic, wood, or metal. In preferred embodiments, the tray assembly 100 is formed from a plastic sheet, for example an Acrylonitrile Butadiene Styrene (ABS) plastic sheet. In a preferred embodiment, the tray assembly 100 is formed from an ABS plastic sheet that has a thickness in a range of 0.1 inches to 0.5 inches, preferably approximately 0.25 inches thick. It will be appreciated that the type of material used and thickness of the material used can vary depending on the expected load to be supported by the shelf 102. Since the shelf 102 is supported in a cantilever fashion by the support tabs 108, 110, no additional support arms are needed.

It is to be understood that the term “tripod” as used herein encompasses any tripodic device, that is, one having three legs, for which a work/storage surface would be a useful addition. These devices may include but are not limited to artist easels, display easels, office easels, surveyor tripods, camera tripods, telescope tripods, or tripods for other optical or measuring devices.

In a preferred embodiment, the slots 104, 106 are wide enough to accommodate tripod legs that are approximately 0.75 inches in diameter. However, in alternative embodiments, the slots 104, 106 of the tray assembly 100 can be sized and shaped so as to accommodate alternative sizes and types of tripod units 200, including but not limited to square leg tripods, larger diameter tripod legs, longer spaces between tripod legs, and non-easel tripods, without departing from the spirit and scope of the present invention.

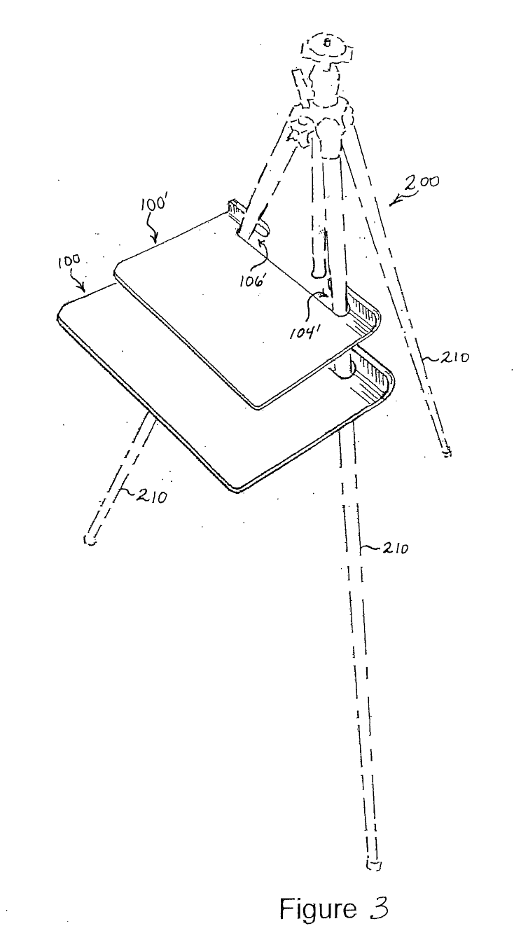

Referring next to FIG. 3, which shows a perspective view of a pair of tray assemblies 100 and 100′. The tray assembly 100′ is similar to the tray assembly 100. A primary difference between the tray assembly 100 and the tray assembly 100′ is that the tray assembly 100′ is smaller than the tray assembly 100. Specifically the distance between the slots 104′ and 106′ of the tray assembly 100′ is less than the distance between the slots 104 and 106 of the tray assembly 100. As a result, when the tray assembly 100′ is installed onto the tripod 200, it rests higher on the tripod legs 210 than the tray assembly 100. Thus, the tray assemblies 100, 100′ can be simultaneously installed onto a same pair of legs 210 of a tripod 200. It will be appreciated that additional tray assemblies 100 can be installed by providing tray assemblies of different sizes, specifically where the distances between the slots 104,106 are varied.

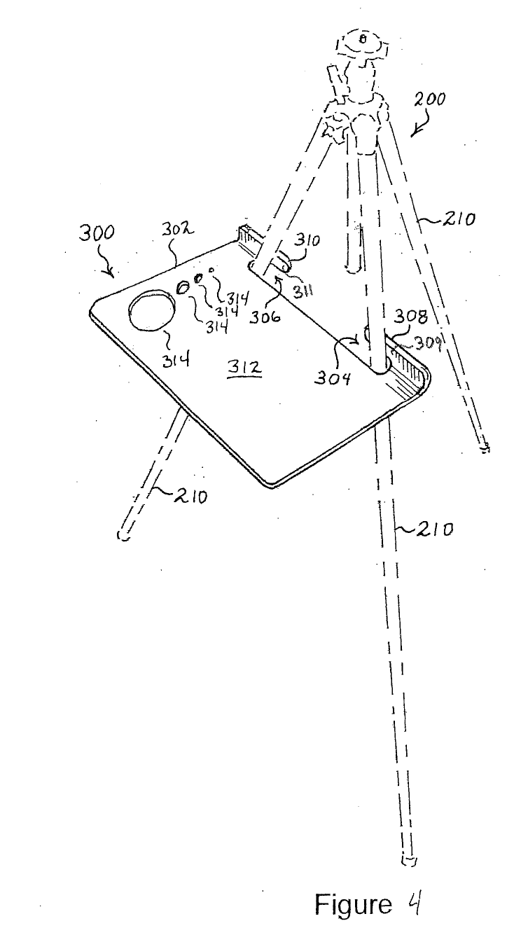

Referring next to FIG. 4, an alternative embodiment of the tray assembly 300 is shown. The tray assembly 300 is similar to the tray assembly 100. The tray assembly 300 includes a shelf 302 that mounts onto two of the tripod legs 210 at slots 304, 306. The shelf 302 is supported in a cantilever fashion by a pair of support tabs 308, 310. The support tabs 308, 310 have respective contact surfaces 309, 311, and at least a portion of each of the contact surfaces 309, 311 is intended to contact a respective tripod leg 210 when the tray assembly 300 is installed. The shelf 302 hangs off the tripod 200 away from the tripod 200, thus providing a level, accessible work and storage surface 312 for an artist or other tripod user. A user can remove the tray assembly 300 from the tripod 200 by simply lifting the tray assembly 300 up and away from the tripod 200. Note that in a preferred embodiment, the entire contact surfaces 309, 311 extend substantially perpendicular to the surface 312. However, in alternative embodiments the angle between the surface 312 and the contact surfaces 309, 311 can be greater than 90 degrees so as to more closely match the angle of the tripod legs 210 relative to the surface 312.

The tray assembly 300 also includes a plurality of holes 314. The holes 314 can vary in size as shown in FIG. 4. In some embodiments, such as embodiments where the tray assembly 300 is intended for use as an artist's tray, the size and shape of the holes 314 can be configured so as to be useful for holding various paint brushes, paint containers, water containers, or other art tools. In other embodiments, such as embodiments where the tray assembly 300 is intended for use as a photographer's tray, the size and shape of the holes 314 can be configured so as to be useful for holding various camera lenses, film containers, or other camera accessories. In still other embodiments, such as embodiments where the tray assembly 300 is intended for use with a telescope, the size and shape of the holes 314 can be configured so as to be useful for holding various telescope lenses, a compass, lens caps, or other telescope accessories. It should be appreciated that in still further embodiments, any number of holes 314 of various shapes and sizes can be provided for various uses. It should also be noted that one or more wells of various size, shape, and depth can be formed in place of, or in addition to, the holes 314.

Like the tray assembly 100, the tray assembly 300 is formed of rigid material, such as plastic, wood, or metal. In preferred embodiments, the tray assembly 300 is formed from a plastic sheet, for example an ABS plastic sheet. In a preferred embodiment, the tray assembly 300 is formed from an ABS plastic sheet that has a thickness in a range of 0.1 inches to 0.5 inches, preferably approximately 0.25 inches thick. It will be appreciated that the type of material used and thickness of the material used can vary depending on the expected load to be supported by the shelf 302. Since the shelf 302 is supported in a cantilever fashion by the support tabs 308, 310, no additional support arms are needed.

In a preferred embodiment, the slots 304, 306 are wide enough to accommodate tripod legs that are approximately 0.75 inches in diameter. However, in alternative embodiments, the slots 304, 306 of the tray assembly 300 can be sized and shaped so as to accommodate alternative sizes and types of tripod units 200, including but not limited to square leg tripods, larger diameter tripod legs, longer spaces between tripod legs, and non-easel tripods, without departing from the spirit and scope of the present invention.

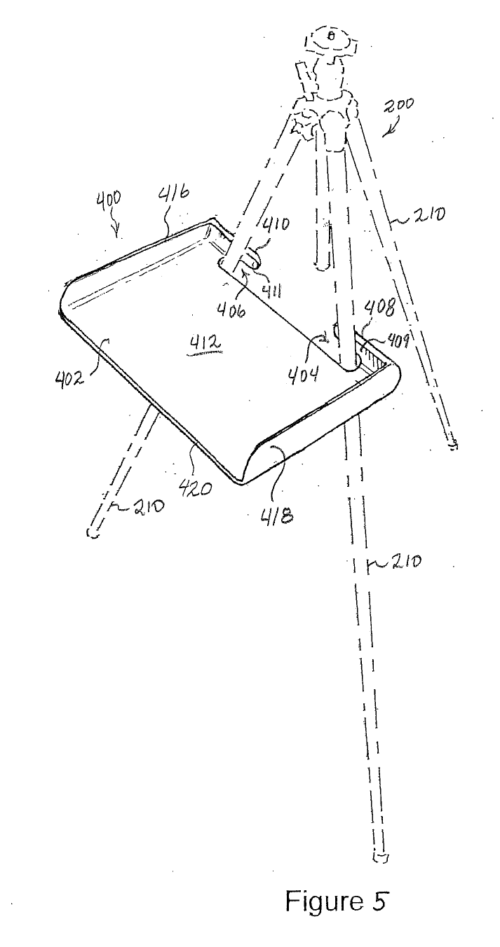

Referring next to FIG. 5, another alternative embodiment of the tray assembly 400 is shown. The tray assembly 400 is similar to the tray assembly 100. The tray assembly 400 includes a shelf 402 that mounts onto two of the tripod legs 210 at slots 404, 406. The shelf 402 is supported in a cantilever fashion by a pair of support tabs 408, 410. The support tabs 408, 410 have respective contact surfaces 409, 411, and at least a portion of each of the contact surfaces 409, 411 is intended to contact a respective tripod leg 210 when the tray assembly 400 is installed. The shelf 402 hangs off the tripod 200 away from the tripod 200, thus providing a level, accessible work and storage surface 412 for an artist or other tripod user. A user can remove the tray assembly 400 from the tripod 200 by simply lifting the tray assembly 400 up and away from the tripod 200. Note that in a preferred embodiment, the entire contact surfaces 409, 411 extend substantially perpendicular to the surface 412. However, in alternative embodiments the angle between the surface 412 and the contact surfaces 409, 411 can be greater than 90 degrees so as to more closely match the angle of the tripod legs 210 relative to the surface 412.

The tray assembly 400 also includes a pair of side walls 416 and 418 that extend along opposing edges of the surface 412. The side walls 416 and 418 can extend the full length of the edges of the surface 412 as shown in FIG. 5, or alternative can extend along only a portion of the edges of the surface 412. It should be appreciated that an additional side wall can extend along the front edge 420 of the surface 412 in combination with, or instead of, the side walls 416 and 418. The side walls 416 and 418 help retain items on the surface 412, for example pencils or other items that are prone to rolling. The side walls 416 and 418 also provide added strength to the shelf 402 to assist in resistance of the shelf 402 to bowing or flexing. The side walls 416 and 418 can also be used to support a removable tray or liner (not shown) that extends over all or part of the surface 412 and up and over at least a portion of the side walls 416, 418. For example, a disposable liner could be provided for covering the surface 412 so that the shelf 416 can be used as a paint palette without getting paint on the surface 412 of the shelf 416.

Like the tray assembly 100, the tray assembly 400 is formed of rigid material, such as plastic, wood, or metal. In preferred embodiments, the tray assembly 400 is formed from a plastic sheet, for example an ABS plastic sheet. In a preferred embodiment, the tray assembly 400 is formed from an ABS plastic sheet that has a thickness in a range of 0.1 inches to 0.5 inches, preferably approximately 0.25 inches thick. It will be appreciated that the type of material used and thickness of the material used can vary depending on the expected load to be supported by the shelf 402. Since the shelf 402 is supported in a cantilever fashion by the support tabs 408, 410, no additional support arms are needed.

in a preferred embodiment, the slots 404, 406 are wide enough to accommodate tripod legs that are approximately 0.75 inches in diameter. However, in alternative embodiments, the slots 404, 406 of the tray assembly 400 can be sized and shaped so as to accommodate alternative sizes and types of tripod units 200, including but not limited to square leg tripods, larger diameter tripod legs, longer spaces between tripod legs, and non-easel tripods, without departing from the spirit and scope of the present invention.

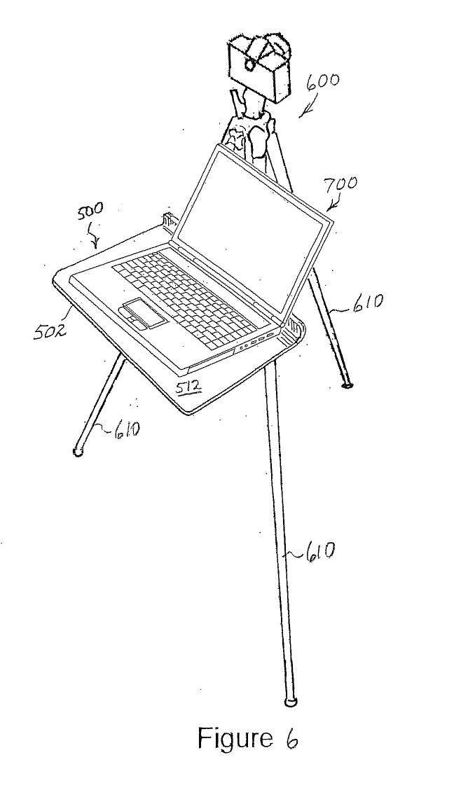

Referring next to FIG. 6, another alternative embodiment of the tray assembly 500 is shown. The tray assembly 500 is similar to the tray assembly 100. The tray assembly 500 is shown attached onto a camera tripod 600. A camera 602 is also mounted to the camera tripod 600. The tray assembly 500 includes a shelf 502 that mounts onto two of the tripod legs 610 at slots that are not shown in FIG. 6, but can appear the same as the slots 104, 106 in FIG. 1. The shelf 502 is supported in a cantilever fashion by a pair of support tabs (not shown in FIG. 6, but can appear the same as the support tabs 108, 110 shown in FIG. 1). The support tabs have respective contact surfaces, and at least a portion of each of the contact surfaces is intended to contact a respective tripod leg 610 when the tray assembly 500 is installed. The shelf 502 hangs off the tripod 600 away from the tripod 600, thus providing a level, accessible surface 512 for supporting a laptop computer 700. A user can remove the tray assembly 500 from the tripod 600 by simply lifting the tray assembly 500 up and away from the tripod 600. Note that in a preferred embodiment, the entire contact surfaces of the support tabs extend substantially perpendicular to the surface 512. However, in alternative embodiments the angle between the surface 512 and the contact surfaces can be greater than 90 degrees so as to more closely match the angle of the tripod legs 610 relative to the surface 512.

The tray assembly 500 can optionally include an auxiliary power supply for the laptop computer 700. The tray assembly 500 can also optionally include holes, such as holes 314 shown in FIG. 4, and/or wells (not shown) for storing camera and/or computer accessories. Like the tray assembly 100, the tray assembly 500 is formed of rigid material, such as plastic, wood, or metal. In preferred embodiments, the tray assembly 500 is formed from a plastic sheet, for example an ABS plastic sheet. In a preferred embodiment, the tray assembly 500 is formed from an ABS plastic sheet that has a thickness in a range of 0.1 inches to 0.5 inches, preferably approximately 0.25 inches thick. It will be appreciated that the type of material used and thickness of the material used can vary depending on the expected load to be supported by the shelf 502. Since the shelf 502 is supported in a cantilever fashion by the support tabs, no additional support arms are needed.

In a preferred embodiment, the slots of the tray assembly 500 are wide enough to accommodate tripod legs that are approximately 0.75 inches in diameter. However, in alternative embodiments, the slots of the tray assembly 500 can be sized and shaped so as to accommodate alternative sizes and types of tripod units 600, including but not limited to square leg tripods, larger diameter tripod legs, longer spaces between tripod legs, and non-easel tripods, without departing from the spirit and scope of the present invention.

While the shelves 102, 302, 402, and 502 of the tray assemblies are shown in the figures as being generally rectangular in shape, it should be appreciated that the tray assembly can be designed with other shapes, such as more round or oval shapes.

In some embodiments, the surfaces 112, 312, 412, and 512 can be substantially smooth. In other embodiments, the surfaces 112, 312, 412, and 512 can be rough and textured. In some embodiments, the surfaces 112, 312, 412, and 512 can be formed so as to have a high friction coefficient so as to prevent items from sliding.

The tray assemblies 100, 300, 400, and 500 can be any desired color and/or provided with decorative patterns or designs, including various degrees of transparency.

It is apparent that an invention with significant advantages has been described and illustrated. Although the present invention is shown in a limited number of forms, it is not limited to just these forms, but is amenable to various changes and modifications without departing from the spirit thereof.

I claim:

1. A removable tray assembly for use with a tripod, the removable tray assembly comprising:
a shelf having a back edge, a front edge, and two side edges;
a first support tab and a second support tab;
a first slot disposed between the back edge of the shelf and the first support tab for receiving a first leg of the tripod, and a second slot disposed between the back edge of the shelf and the second support tab for receiving a second leg of the tripod;
wherein the first and second support tabs are arranged so as to support the shelf in a cantilever fashion when the tray assembly is installed onto the tripod.

2. The removable tray assembly according to claim 1, further comprising a plurality of holes of different sizes through the shelf.

3. The removable tray assembly according to claim 1, further comprising at least one side wall extending along one of the side edges of the shelf.

4. The removable tray assembly according to claim 1, wherein the shelf and support tabs are formed from a plastic sheet.

5. The removable tray assembly according to claim 1, wherein the shelf and support tabs are formed from Acrylonitrile Butadiene Styrene.

6. A tripod assembly comprising:
a tripod; and
a removable tray assembly comprising:
a shelf having a back edge, a front edge, and two side edges;
a first support tab and a second support tab;
a first slot disposed between the back edge of the shelf and the first support tab for receiving a first leg of the tripod, and a second slot disposed between the back edge of the shelf and the second support tab for receiving a second leg of the tripod;
wherein the first and second support tabs are arranged so as to support the shelf in a cantilever fashion when the tray assembly is installed onto the tripod.

7. The tripod assembly according to claim 6, further comprising a plurality of holes of different sizes through the shelf.

8. The tripod assembly according to claim 6, further comprising at least one side wall extending along one of the side edges of the shelf.

9. The tripod assembly according to claim 6, wherein the shelf and support tabs are formed from a plastic sheet.

10. The tripod assembly according to claim 6, wherein the shelf and support tabs are formed from Acrylonitrile Butadiene Styrene

11. A photography system comprising:
a tripod configured for supporting a camera;
a removable tray assembly comprising:
a shelf having a back edge, a front edge, and two side edges;
a first support tab and a second support tab;
a first slot disposed between the back edge of the shelf and the first support tab for receiving a first leg of the tripod, and a second slot disposed between the back edge of the shelf and the second support tab for receiving a second leg of the tripod;
wherein the first and second support tabs are arranged so as to support the shelf in a cantilever fashion when the tray assembly is installed onto the tripod.

12. The photography system according to claim 11, further comprising a plurality of holes of different sizes through the shelf.

13. The photography system according to claim 11, further comprising at least one side wall extending along one of the side edges of the shelf.

14. The photography system according to claim 11, wherein the shelf and support tabs are formed from a plastic sheet.

15. The photography system according to claim 11, wherein the shelf and support tabs are formed from Acrylonitrile Butadiene Styrene.
